(19) United States
(12) Patent Application Publication
(10) Pub. No.: US 2018/0121234 A1
(43) Pub. Date: May 3, 2018

(54) METHOD AND ASSOCIATED PROCESSOR FOR IMPROVING SOFTWARE EXECUTION OF ELECTRONIC DEVICE

(71) Applicant: MEDIATEK INC., Hsin-Chu (TW)

(72) Inventors: Yi-Chin Lin, Pingtung City (TW); Tzu-Chieh Ou, Tainan City (TW); Yung-Jui Kuo, Zhubei City (TW); Yi-Ping Chiu, Kaohsiung City (TW); Chun-Yi Chen, New Taipei City (TW)

(21) Appl. No.: 15/697,538

(22) Filed: Sep. 7, 2017

Related U.S. Application Data
(60) Provisional application No. 62/414,028, filed on Oct. 28, 2016.

(51) Int. Cl. G06F 9/48; G06F 9/445; G06F 17/30

(52) U.S. Cl. CPC G06F 9/485; G06F 17/30964; G06F 9/44594

(57) ABSTRACT

The invention provides a method and associated processor for improving software execution of an electronic device. The method may comprise: by a processor of the electronic device, identifying whether a target program is classified, according to whether the target program relates to an user interface of the electronic device, as one of suppressible programs; and, based on whether at least one suppression condition is satisfied, performing at least one suppressing operation on one or more of the suppressible programs.

This application claims the benefit of U.S. provisional application Ser. No. 62/414,028, filed Oct. 28, 2016, the disclosure of which is incorporated by reference herein in its entirety.

### FIELD OF THE INVENTION

The present invention relates to method and associated processor for improving software execution of electronic device, and more particularly, to method and associated processor improving software execution by identifying suppressible programs (e.g., applications and/or components such as activities, services, etc.) classified considering user experience, along with varied suppressing operations performed under diversified suppression conditions to suppress the suppressible programs.

### BACKGROUND OF THE INVENTION

Electronic device, such as smart cellular phone, tablet computer, portable computer, hand-held computer, digital camera, camcorder, game console, navigator, wearable device (e.g., wrest watch, eye glasses) or smart home device has become an essential portion of contemporary life, and is broadly utilized to serve many needs of user, including business and productivity, telecommunication, social networking, gaming and entertaining; information, readings and news feeding; real-time communicating, chatting, messaging and/or collaborating; e-mail composing, sending and/or receiving; media recording, playing, editing and streaming; educating and learning; buying, selling and shopping; web browsing, financing and banking; lifestyle enriching, travel planning and route navigating; health and fitness monitoring and managing; and/or calendar and daily schedule arranging and date reminding, etc.

Electronic device executes different software programs, including applications and/or components (e.g., activities, services, content providers and/or broadcast receivers utilized in Android) to serve different user needs. Executing each program consumes system resources, including RAM (random access memory) space, time, bus bandwidth and power. As an electronic device keeps on working and undergoes execution of more and more programs, if there lacks proper and effective mechanism for managing program execution, system resource of the electronic device will be exhausted, and the electronic device will consequently suffer from sluggish response, decreased performance, raised temperature, shortened battery life and degraded user experience.

To address aforementioned issues, a prior art ranks power (or resource) consumption of currently running applications, so the most power-consuming (or resource-consuming) application(s) can be terminated, e.g., by user or system. Another prior art monitors applications that are running background, and terminates any background application that self-launches but is predetermined to be forbidden. The prior arts suffer the following disadvantages. First, the prior arts terminate an application after the application has been launched, and hence fail to rapidly and effectively avoid undesired application from launching.

Moreover, the prior arts will erroneously terminate applications that are essential to user, and/or terminate applications that relate to foreground applications. For example, a user may want to keep contact with others by instant messaging which requires a messaging application, but will lose contact when the messaging application is identified as a power-consuming application and incorrectly terminated. Similarly, a foreground application which relies on a background service will be adversely affected when the background service is incorrectly terminated.

Further, the prior arts may be passively initiated by user to temporally terminate currently running applications, and therefore fail to prevent applications from being automatically launched afterwards.

### SUMMARY OF THE INVENTION

An objective of the invention is providing a method (e.g., FIG. 1) for improving software execution of an electronic device (e.g., 210 in FIG. 2). The method may comprise: by a processor (e.g., 204 in FIG. 2) of the electronic device, identifying whether a target program is classified as one of suppressible programs (e.g., 106 in FIG. 1) according to whether (e.g., 1b and/or 3b in FIG. 6) the target program relates to an user interface (e.g., 300 in FIG. 3) of the electronic device; and, based on whether at least one suppression condition is satisfied (e.g., 108 in FIG. 1), performing at least one suppressing operation on one or more of the suppressible programs (e.g., 110 in FIG. 1).

In an embodiment, whether the target program is classified as one of the suppressible programs may be further according to whether the target program is one of most recently executed programs (e.g., 3a in FIG. 6). In an embodiment, whether the target program is classified as one of the suppressible programs may be further according to whether the target program is launched by another program that is not suppressed (e.g., 4a in FIG. 6).

In an embodiment, the method may further comprise: forming a foreground relation chain (FRC, e.g., 700 in FIG. 7) by: including a first program (e.g., 701) as a member of the FRC if the first program is launched by user, and including a second program (e.g., 702 or 703) as a member of the FRC if the second program is launched by any member of the FRC; wherein whether the target program is classified as one of the suppressible programs may be further according to whether the target program is launched by any member of the FRC (e.g., 4b in FIG. 6).

In an embodiment, whether the target program is classified as one of the suppressible programs may be further according to whether the target program is required by an operating system executed by the processor (e.g., 3c in FIG. 6).

In an embodiment, the method may further comprise: by the processor, accessing a database (e.g., 402 in FIG. 4) to obtain a category of the target program (e.g., 102 in FIG. 1); wherein whether the target program is classified as one of the suppressible programs may be further according to the category of the target program (e.g., 2a in FIG. 6).

In an embodiment (e.g., FIG. 5), the at least one suppression condition may comprise a first (e.g., event-triggered) suppression condition which is satisfied when a first event happens, and the first event may be one of the following: launching a first predetermined program, leaving a second predetermined program, pausing a third predetermined program, resuming a fourth predetermined program, switching between two predetermined programs, starting a telecommunication function, idling an operation system executed by the processor, waking the operation system, locking a screen (e.g., 208 in FIG. 2) of the electronic device, unlocking the screen, turning on the screen and turning off the screen. In an embodiment, the at least one suppression condition may comprise a second (e.g., delayed) suppression condition which is satisfied when a predetermined interval elapses after a predetermined event happens. In an embodiment, the at least one suppression condition may comprise a third (e.g., leading) suppression condition and a fourth (e.g., follow-up) suppression condition, and whether the fourth suppression condition is satisfied may relate to whether the third suppression conditions is satisfied. In an embodiment (e.g., FIG. 8), performing the at least one suppressing operation may comprise: performing two different ones of the at least one suppressing operation respectively when the third suppression condition is satisfied and when the fourth suppression condition is satisfied.

In an embodiment (e.g., FIG. 5), the at least one suppressing operation may comprise a first suppressing operation and a second suppressing operation. The first suppressing operation may comprise: killing loaded ones of the suppressible programs. The second suppressing operation may comprise: preventing unloaded ones of the suppressible programs from being launched by a user-unattended event.

In an embodiment, the method may further comprise: keeping on performing the at least one suppressing operation on the one or more of the suppressible programs after the at least one suppression condition is satisfied (e.g., 110 in FIG. 1), and stopping performing the at least one suppressing operation on the one or more of the suppressible programs (e.g., 114) when a stop condition is satisfied (e.g., 112).

In an embodiment, the method may further comprise: after performing the at least one suppressing operation on the one or more of the suppressible programs, restoring one or more of the suppressed ones of the suppressible programs when a stop condition is satisfied (e.g., 114 in FIG. 1). In an embodiment (e.g., FIG. 9b), the method may further comprise: preserving a status of one of the one or more of the suppressible programs when performing the at least one suppressing operation on (e.g., killing) the one or more of the suppressible programs, so as to enable the one of the one or more of the suppressible programs to restore the status when relaunched.

An objective of the invention is providing a processor (e.g., 204 in FIG. 2) of an electronic device (e.g., 210). The processor may comprise: a core unit (e.g., 200), and an interface circuit (e.g., 202) bridging between the core unit and a peripheral circuit (e.g., 206) of the electronic device. The core unit may be arranged to identify at least one program which is classified as at least one suppressible program (e.g., 106 in FIG. 1) according to whether the at least one program relates to an user interface of the electronic device; and, based on whether at least one suppression condition is satisfied (e.g., 108), perform at least one suppressing operation on one or more of the at least one suppressible program (e.g., 110).

The core unit may be arranged to identify the at least one program which is classified as the at least one suppressible program further according to, e.g., whether the at least one program is one of most recently executed programs, and/or whether the at least one program is launched by any member of the FRC.

Numerous objects, features and advantages of the present invention will be readily apparent upon a reading of the following detailed description of embodiments of the present invention when taken in conjunction with the accompanying drawings. However, the drawings employed herein are for the purpose of descriptions and should not be regarded as limiting.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 illustrates a flow for improving software execution according to an embodiment of the invention;

FIG. 2 illustrates an electronic device according to an embodiment of the invention;

FIG. 3 illustrates an example of a UI;

FIG. 4 illustrates a flow for obtaining a category of a program according to an embodiment of the invention;

FIG. 5 illustrates examples of varied suppression conditions and suppressing operations according to an embodiment of the invention;

FIG. 6 illustrates examples of rules for classifying suppressible programs;

FIG. 7 illustrates an example of an FRC according to an embodiment of the invention;

FIG. 8 illustrates an example of two-phase suppressing operations under a leading suppression condition and a follow-up suppression condition according to an embodiment of the invention; and

FIGS. 9a and 9b illustrate examples of restoring a suppressed program according to embodiments of the invention.

### DETAILED DESCRIPTION OF PREFERRED EMBODIMENTS

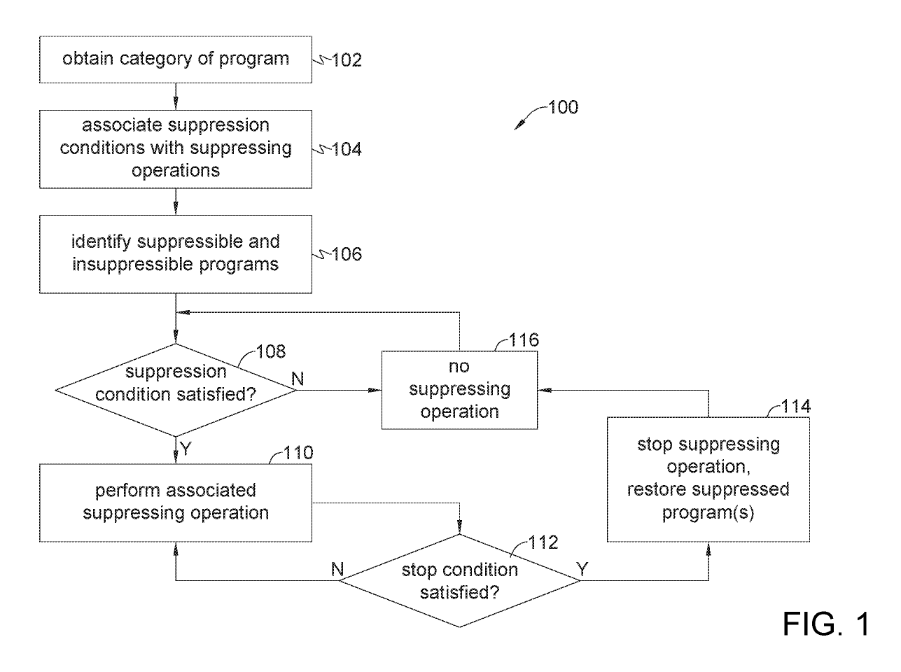

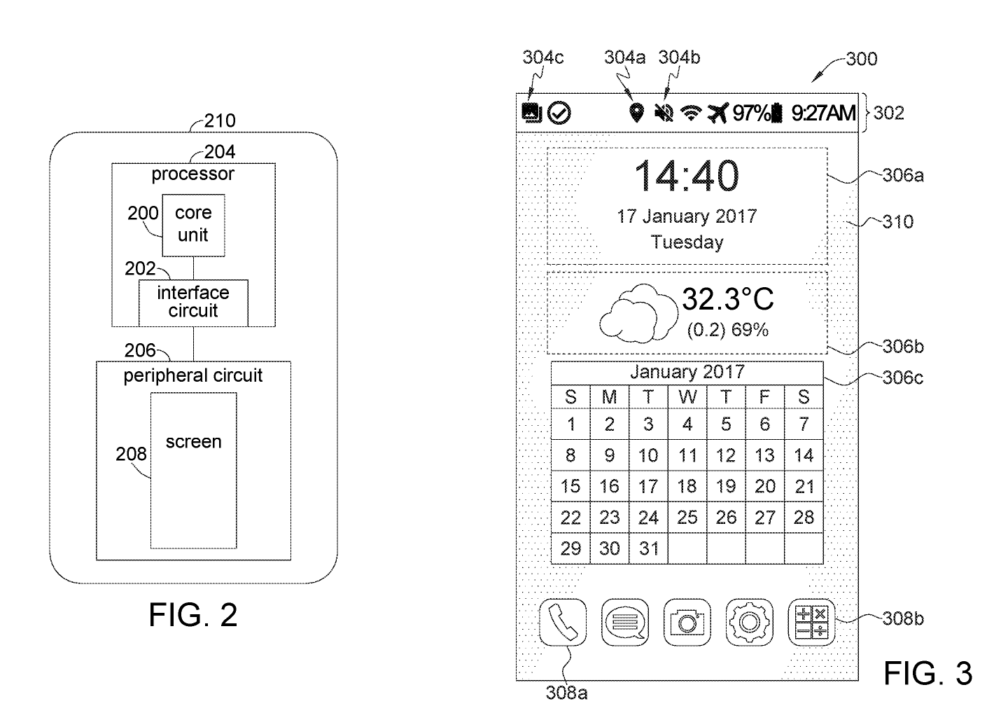

Please refer to FIG. 1 and FIG. 2; FIG. 1 illustrates a flow 100 according to an embodiment of the invention, and FIG. 2 illustrates an electronic device 210 according to an embodiment of the invention, wherein a processor 204 of the electronic device 210 may implement the flow 100 to manage system resources and improve software execution of the electronic device 210. As shown in FIG. 2, the processor 204 may include a core unit 200 and an interface circuit 202. The core unit 200 may include logic circuitry for executing software and/or firmware operation system, codes and programs; wherein programs may include applications and/or components, i.e., building blocks of applications, such as activities, services, content providers and/or broadcast receivers utilized in Android. The interface circuit 202 may bridge between the core unit 200 and a peripheral circuit 206 of the electronic device 210. For example, the interface circuit 202 may include circuitry for data input and/or output, and the peripheral circuit 206 may include circuitry for controlling a screen 208, such that the core unit 200 may instruct the screen 208 to demonstrate visual elements of a user interface (UI) of the electronic device 210. For example, as shown in FIG. 3, a visual UI 300 shown on the screen 208 of FIG. 2 may include various visual UI elements, such as a desktop image 310, program icons 308a and 308b, a status bar 302 with notification icons 304a, 304b and 304c, and/or widgets 306a, 306b and 306c, etc. Besides the screen 208 for visual UI elements, the peripheral circuit 206 may further include actuators (not shown) for other user-perceptible UI elements, such as a speaker for auditory UI elements and/or a vibrator for vibrating UI elements. The peripheral circuit 206 may also include volatile memory (e.g., RAM, not shown) and/or non-volatile memory (e.g., flash memory and/or solid-state drive, not shown).

According to the flow 100, the core unit 200 may identify whether each of installed programs is classified to be suppressible or insuppressible; hence, based on whether at least one suppression condition is satisfied, the core unit 200 may perform at least one suppressing operation on one or more of the suppressible programs. As shown in FIG. 1, major steps of the flow 100 may be describes as follows.

Step 102: the core unit 200 may obtain a category of an installed program. To help user to comprehensively understand purpose, contents, usage and/or other information of a program, developer of the program may be requested to categorize the program to one of plural known categories when publishing the program. Because user may favor programs of one or more categories, the category of a program may be obtained and then be considered when determining if the program is suppressible.

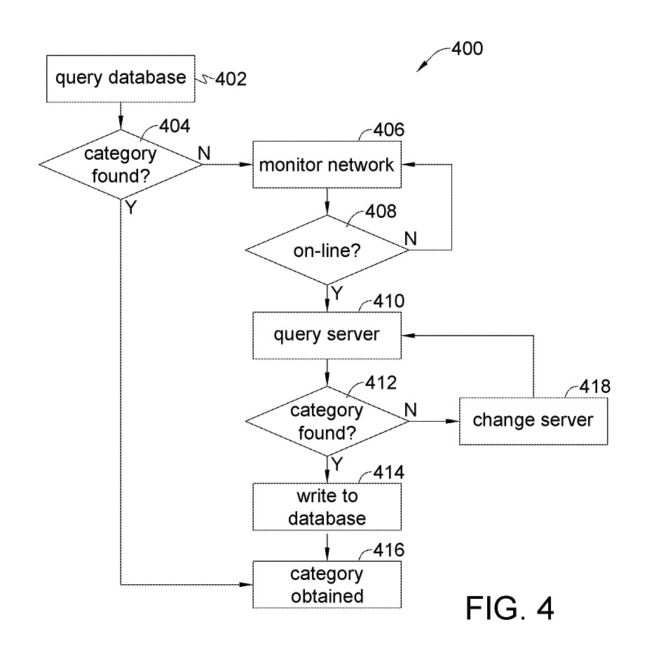

To find a category of a target program (e.g., one of the installed programs), the core unit 200 may execute a flow 400 shown in FIG. 4. As shown in FIG. 4, in step 402, the core unit 200 may query a local database to, in step 404, check if a category of the target program can be found. If the local database already records a category of the target program, the core unit 200 may proceed to step 416. On the other hand, if the local database has not recorded a category of the target program, then the core unit 200 may proceed to step 406. In an embodiment, the database may be implemented by a non-volatile memory (not shown) in the peripheral circuit 206 (FIG. 2), and be accessed by the core unit 200 via the interface circuit 202.

In step 406, the core unit 200 may keep on monitoring network to, in step 408, check whether the electronic device 210 is on-line. For example, the peripheral circuit 206 (FIG. 2) may include a network interface circuit (not shown) for wired and/or wireless communication with remote servers. If the electronic device 210 is on-line, the core unit 200 may proceed to step 410; if the electronic device 210 is off-line (not on-line), the core unit 200 may iterate to step 406. In step 410, the core unit 200 may query a server to, in step 412, check if a category of the target program can be found. If the category is found in step 412, the core unit 200 may proceed to step 414 for writing the found category to the local database for the target program, and then proceed to step 416.

On the other hand, in step 412, if the category is not found, the core unit 200 may proceed to step 418 to change to a different server for repeating step 410. For example, when step 410 is executed for the first time, the core unit 200 may query a first server; if a category is not found in the first server, step 410 may be executed for the second time, and the core unit 200 may query a second server. The first server may offer an official marketplace (e.g., app store) for releasing officially verified programs, and the second server (and subsequent servers) may be other essential program distributor(s). In step 416, the category of the target program has been found, and the core unit 200 may end the flow 400.

Step 104 (FIG. 1): as an optional step, the core unit 200 may associate one or more suppression conditions with one or more suppressing operations. Afterwards (e.g., steps 108 and 110), when a suppression conditions is satisfied, the core unit 200 may perform the associated one or more suppressing operations on one or more of the suppressible programs.

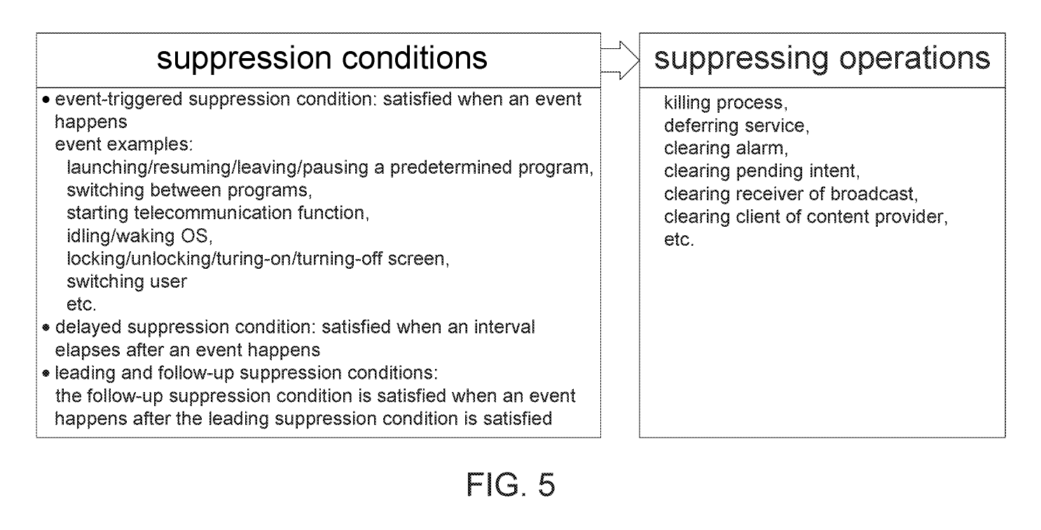

As shown in FIG. 5, in an embodiment, the suppression conditions may include one or more event-triggered suppression conditions, each event-triggered suppression condition may be satisfied when an associated event happens. Various events for different event-triggered suppression conditions may include: launching a first predetermined program, leaving a second predetermined program (e.g., a launcher) to launch other program(s), pausing a third predetermined program (e.g., beginning to pause an activity), resuming a fourth predetermined program (e.g., beginning to resume an activity and/or finishing resumption of an activity), switching between two predetermined programs (e.g., switching between two activities), starting a telecommunication function (e.g., answering a call or finishing a call), idling the operation system executed by the processor 204 (FIG. 2), waking the operation system, locking the screen 208, unlocking the screen 208, turning on the screen 208, turning off the screen 208, and/or performing a user switch, etc.

For example, the suppression conditions may include a first suppression condition which may be satisfied when launching a first program, a second suppression condition which may be satisfied when leaving a second program, a third suppression condition which may be satisfied when pausing a third program, and a fourth suppression condition which may be satisfied when resuming a fourth program, etc. The first, second, third and fourth programs may be identical or different; for example, the first program may be a gaming program, and the second program may be a launcher.

As shown in FIG. 5, in an embodiment, the suppression conditions may include one or more delayed suppression conditions, each delayed suppression condition may be satisfied when a predetermined interval elapses after a predetermined event happens. For example, there may be a suppression condition which is satisfied when 100 milliseconds elapses after launching a predetermined program.

As shown in FIG. 5, each of the suppressing operations may include: killing process, deferring service, clearing alarm, clearing pending intent, clearing receiver of broadcast, and/or clearing client of content provider, etc. For example, a first suppressing operation may include: killing processes of loaded suppressible programs, i.e., programs which are classified to be suppressible and have been loaded into RAM when performing the first suppressing operation. A second suppressing operation may include: preventing unloaded suppressible programs from being launched by user-unattended event(s), such as scheduled job or alarm, pending intent and/or broadcast between programs. The second suppressing operation may be achieved by, e.g., clearing alarm(s) and/or pending intent(s) designated to automatically launch programs that are classified to be suppressible and have not been loaded into RAM when performing the second suppressing operation.

Associating various suppression conditions with different suppressing operations may enhance flexibility and adaptability of program suppression and resource management. Different combinations of suppression condition and suppressing operation may be set to adapt variety of scenarios. For example, a suppression condition which is satisfied when a messaging program launches may be associated with a suppressing operation of killing processes of loaded suppressible programs. Similarly, another suppression condition which is satisfied when a program begins to pause may also be associated with the same suppressing operation of killing processes of loaded suppressible programs. On the other hand, another suppression condition which is satisfied when turning on the screen may be associated with another suppressing operation including killing loaded suppressible programs, as well as clearing alarms and pending intents of unloaded suppressible programs. The electronic device 210 may include default suppression conditions, default suppressing operations and default associations between the suppression conditions and the suppressing operations, and allow user to customize, e.g., to manually add a suppression condition, edit a default suppression condition, and/or modify an existed association by associating another suppression condition with the original suppressing operation.

As shown in FIG. 5, in an embodiment, the suppression conditions may include a leading suppression condition and a follow-up suppression condition; whether the follow-up suppression condition is satisfied relates to whether the leading suppression condition is satisfied. For example, the follow-up suppression condition may be satisfied when an event happens after the leading suppression condition has satisfied.

The core unit 200 may associate the leading suppression condition and the follow-up suppression condition with two different suppressing operations to implement two-phase suppression. For example, the leading suppression condition may be satisfied when the core unit 200 leaves a launcher, and may be associated with a phase-one suppressing operation of killing loaded suppressible programs; the follow-up suppression condition may be satisfied when the core unit 200 launches a gaming program after leaving the launcher, and may be associated with a phase-two suppressing operation, which may include clearing alarms and pending intents which are designated to launch unloaded suppressible programs.

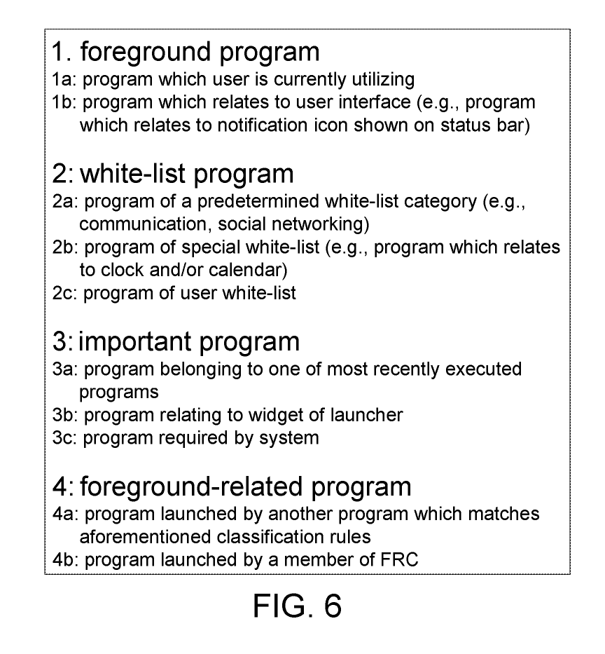

Step 106 (FIG. 1): from all installed programs, the core unit 200 may identify whether each installed program is classified as a suppressible or insuppressible program. Along with FIG. 1 and FIG. 2, please refer to FIG. 6; which illustrates, according to an embodiment of the invention, various rules for classifying whether a target program (e.g. an arbitrary one of the installed programs) is suppressible or insuppressible. According to a main rule 1 shown in FIG. 6, if the target program is a foreground program, then the target program may be classified as an insuppressible program. For example, as stated in a rule 1a of the main rule 1, if the target program is a program which user is currently utilizing (interacting), the target program may be classified to be insuppressible, because suppressing the target program may cause undesired interruption of user experience.

In addition, as stated in a rule 1b, if the target program relates to UI (e.g., relates to an element of UI), then the target program may be classified to be insuppressible. For example, if the target program is a location service related to the notification icon 304a (FIG. 3) which reflects the location service is activated, then the target program may be classified to be insuppressible, since suppressing the target program may cause undesired disappearance of the notification icon 304a.

According to a main rule 2 in FIG. 6, if the target program is one of white-list programs, then the target program may be classified to be insuppressible. For example, as stated in a rule 2a of the main rule 2, if the target program belongs to one of a number of white-list categories, the target program may be insuppressible. The white-list categories may, for example, include “communication,” “messaging” and/or “social networking.” As stated in a rule 2b, if the target program is listed in a special white-list which may include programs related to clock and/or calendar, then the target program may be classified to be insuppressible. Also, as stated in a rule 2c, if the target program is listed in a user white-list which may include programs specified by user, then the target program may be classified to be insuppressible. In other words, user may add favorite program(s) to the user white-list, so the favorite program(s) may be classified as insuppressible program(s). Similarly, there may be black-list category (or categories), special black-list and/or user black-list for classifying a target program to be suppressible.

According to a main rule 3 in FIG. 6, if the target program is one of important programs, then the target program may be classified as an insuppressible program. For example, as stated in a rule 3a, if the target program is one of most recently executed program(s), the target program may be classified as insuppressible. As stated in a rule 3b, if the target program relates to a widget (e.g., 306a, 306b or 306c in FIG. 3) of a launcher, the target program may be classified to be insuppressible, since suppressing the target program may affect operation of the widget. As stated in a rule 3c, if the target program is required by OS and/or the electronic device 210, the target program may be classified to be insuppressible.

According to a main rule 4 in FIG. 6, if the target program is a foreground-related program, the target program may be classified as an insuppressible program. For example, as stated in a rule 4a, if the target program is launched by another program which matches aforementioned rules and is thus classified to be insuppressible, then the target program may be classified to be insuppressible. As stated in a rule 4b, if the target program is launched by another program which is a member listed in a foreground relation chain (FRC), the target program may be classified as an insuppressible program. While executing the flow 100, the core unit 200 may maintain the FRC by: including a first program as a member of the FRC if the first program is launched by user, and including a second program as a member of the FRC if the second program is launched by any member of the FRC.

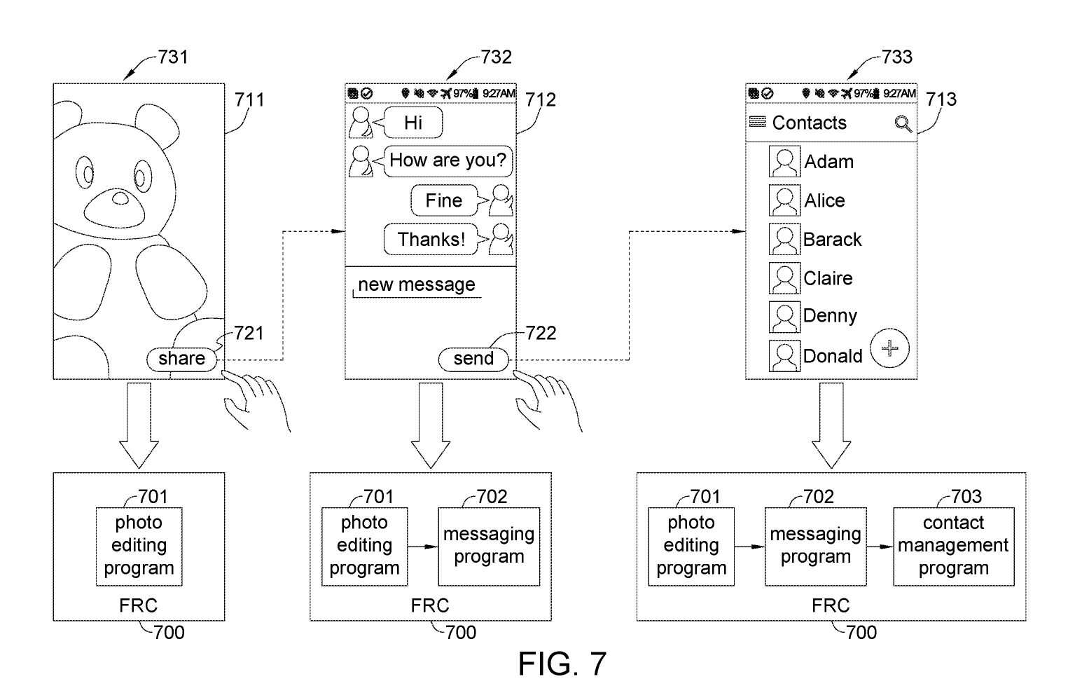

Along with FIGS. 1 and 2, please refer to FIG. 7 illustrating an example of an FRC 700 accompanying a sequence of scenarios 731, 732 and 733. In the example scenario 731, user utilizes a photo editing program 701 with a UI 711 to edit a photo, and the core unit 200 may include the program 701 to the FRC 700. In one example, including the program 701 to the FRC 700 may be performed automatically. Next, user wants to share an edited photo and presses a button 721 which is provided by the UI 711 and designated to launch a messaging program 702 from the program 701 for attaching the edited photo to a message; in response, the core unit 200 may follow the rule 4b to classify the program 702 as insuppressible since the program 702 is launched by a member (the program 701) of the FRC 700, and execute the program 702 without suppressing it, as shown by a UI 712 of the scenario 732; the core unit 200 may also append the program 702 to the FRC 700. Then, user wants to assign a recipient of the message and presses a button 722 which is provided by the UI 712 of the program 702 and designated to launch a contact management program 703 from the program 702 for providing a list of recorded recipients; in response, the core unit 200 may again follow the rule 4b to classify the program 703 as insuppressible since the program 703 is launched by a member (the program 702) of the FRC 700, and execute the program 703 without suppressing it, as shown by a UI 713 of the scenario 733; the core unit 200 may also append the program 703 to the FRC 700.

As user swaps different programs, members of the FRC may dynamically change, e.g., new member(s) may be appended, and/or existed member(s) may be removed from the FRC. The FRC records programs launched according to causality of user intention, and the rules 4a and 4b are designed to honor user intention, so as to maintain an uninterrupted user experience. For example, even though a target program fails to match rules other than the rule 4b, the target program may be classified to be insuppressible if the target program is to be launched by a member of the FRC, so user experience will not be interrupted owing to suppression. On the other hand, the target program may still be classified to be suppressible and may be suppressed if the target program is not to be launched by a member of the FRC.

For a brief summary of the rules in FIG. 6, whether a target program is classified as a suppressible program may be determined collectively according to: whether the target program relates to the user interface (e.g., rule 1a, 1 b, 3b, 4a and/or 4b), whether the target program is one of most recently executed programs (e.g., rule 3a), whether the target program is required by OS executed by the processor 204 (e.g., rule 3c), whether the target program is launched by another program that is not suppressed (e.g., rule 4a and/or 4b), whether the target program is launched by any member of the FRC (e.g., rule 4b), and/or the category of the target program (e.g., rule 2a).

Other than power and/or resource consumption, classification of suppressible programs according to the invention considers web-based categorization and user experience. For example, even though a target program is not a white-list program of the rules 2a, 2b and 2c, the core unit 200 may still classify the target program to be insuppressible if, e.g., the target program is currently in focus and interacting with user (rule 1a), the target program contributes to user-aware element(s) of UI (rule 1b/3b), the target program is one of most recently executed programs (rule 3a), or the target program is to be launched by another launched program (rule 4a) or a member of the FRC (rule 4b).

Classification of suppressible programs according to the invention is also dynamic, flexible and adaptive. For example, a target program may be classified as suppressible under a first scenario, but be classified as insuppressible under a second scenario. As an example, assuming that the program 703 in FIG. 7 fails to match the rules 1a to 1c, 2b to 2c and 3a to 3c; under a scenario (e.g., 731) that user does not manually launch the program 703, the program 703 may be classified as suppressible; however, in a different scenario (e.g., 732) that user triggers a function of a currently running program 702 with the function demanding the program 703, the program 703 may be classified as insuppressible according to the rule 4b. It is noted that an order of steps 102, 104 and 106 may be modified; e.g., step 104 may be executed after step 106.

Step 108 (FIG. 1): the core unit 200 may keep on monitoring if one or more of the suppression conditions are satisfied. If one or more of the suppression conditions are satisfied, the core unit 200 may proceed to step 110; when none of the suppression conditions is satisfied, the core unit 200 may proceed to step 116.

Step 110: when one or more of the suppression conditions are satisfied, the core unit 200 may perform one or more of the suppressing operations on one or more of the suppressible programs. In one example, the one or more suppressing operations may be performed automatically.

For example, the suppression conditions may include a first suppression condition and a second suppression condition. The first suppression condition may be satisfied when the core unit 200 leaves a launcher to launch another program, and may be associated with a first suppressing operation including killing processes of loaded suppressible programs. The second suppression condition may be satisfied when a gaming program launches, and may be associated with a second suppressing operation including killing processes of loaded suppressible programs, along with clearing alarms and pending intents of unloaded suppressible programs. Thus, when user launches any program from the launcher, the core unit 200 may perform the first suppressing operation to kill processes of loaded suppressible programs, and therefore free resources for launching the program. On the other hand, when user launches the gaming program, the core unit 200 may perform the second suppressing operation to kill processes of loaded suppressible programs, and also prevent other unloaded suppressible programs from being automatically launched by upcoming alarms and/or pending intents, so as to maintain uniformly smooth gaming experience through whole gameplay time.

The suppression conditions may include a leading suppression condition and a follow-up suppression condition. For example, the leading suppression condition may be satisfied when the core unit 200 leaves a launcher, and may be associated with a phase-one suppressing operation of killing loaded suppressible programs; the follow-up suppression condition may be satisfied when the core unit 200 launches a messaging program after leaving the launcher, and may be associated with a phase-two suppressing operation, which may include clearing alarms and pending intents designated to launch unloaded suppressible programs, so as to prevent other unloaded suppressible programs from being automatically launched by alarms and pending intents.

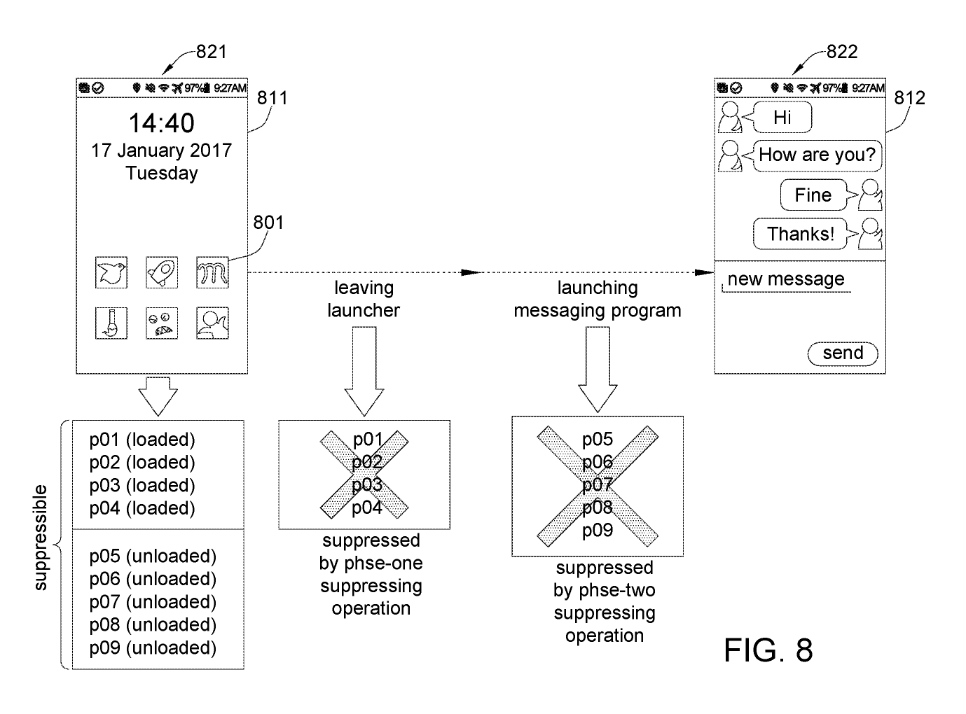

As shown in an example illustrated by FIG. 8, under a scenario 821 when user interacts with a UI 811 of a launcher, it is assumed that programs p01 to p09 are classified to be suppressible, wherein the programs p01 to p04 have been loaded, while the programs p05 to p09 are not loaded. When user engages a program icon 801 of the messaging program shown on the UI 811 of the launcher, the core unit 200 may first leave the launcher and then launch the messaging program with a UI 812 to transit to a scenario 822. When the core unit 200 leaves the launcher, the leading suppression condition is satisfied, and the core unit 200 may therefore perform the phase-one suppressing operation to kill the loaded suppressible programs p01 to p04. When the core unit 200 launches the messaging program after leaving the launcher, the follow-up suppression condition is satisfied, and the core unit 200 may then perform the phase-two suppressing operation to prevent other unloaded suppressible programs p05 to p09 from being automatically launched by alarms and pending intents.

Such sequential two-phase suppression is beneficial, because an attempt to include process killing and alarm/intent clearing in one single suppressing operation to be performed altogether at once may cause a suddenly increased demand of considerable resources, and consequently interrupt launching of the messaging program. Contrarily, performing process killing and alarm/intent clearing separately and sequentially in two phases may spread resource consumption of suppression over time domain. Killing currently loaded suppressible programs when leaving the launcher may only consume minor resources but instantly free major resources for quickly and stably launching the messaging program. On the other hand, clearing pending alarms/intents aims to prevent upcoming launching of unloaded suppressible programs, and may therefore be postponed until the messaging program is stably running.

By adaptive and dynamic classification of suppressible programs, diversified suppression conditions, varied suppressing operations and different associations between the suppression conditions and the suppressing operations, the invention may enrich flexibility and adaptability on which program to suppress, when to suppress and how to suppress, and therefore profoundly improve and enhance program suppression, resource management and software execution.

Step 112 (FIG. 1): in an embodiment, after performing a suppressing operation in step 110, the core unit 200 may keep monitoring if an associated stop condition is satisfied. When the stop condition is satisfied, the core unit 200 may proceed to step 114. If the stop condition is not satisfied, the core unit 200 may maintain the suppressing operation of step 110. The examples of stop conditions may include, but not limited to, a running program is stopped, size of memory free for utilization exceeds a threshold, etc.

Step 114: in an embodiment, the core unit 200 may stop performing the suppressing operation of step 110, and (optionally) perform a restoring operation on the suppressed program(s) for restoring suppressed ones of the suppressible programs. In one example, stopping performing the suppressing operation of step 110 may be executed automatically. There may be a third number (one or more) of stop conditions and a fourth number (one or more) of restoring operations. In one embodiment, each stop condition may be associated with one of the suppression conditions, and/or be associated with one of the suppressing operations. For example, a first suppression condition which is satisfied when a first program launches may be associated with a first stop condition which is satisfied when the first program terminates; a second suppression condition which is satisfied when leaving a second program may be associated with a second stop condition which is satisfied when restarting (returning to) the second program. A first suppressing operation which includes clearing pending intents and alarms of suppressible programs may be associated with a third stop condition which is satisfied when a predetermined time elapses after starting the first suppressing operation.

In one embodiment, each restoring operation may be associated with one of the suppressing operations, and/or be associated with one of the suppression conditions. For example, a first suppressing operation which includes killing loaded suppressible programs may be associated with a first restoring operation which includes relaunching the killed suppressible programs; a second suppressing operation which includes clearing alarms and pending intents of suppressible programs may be associated with a second restoring operation which includes enabling alarms and pending intents of the suppressible programs.

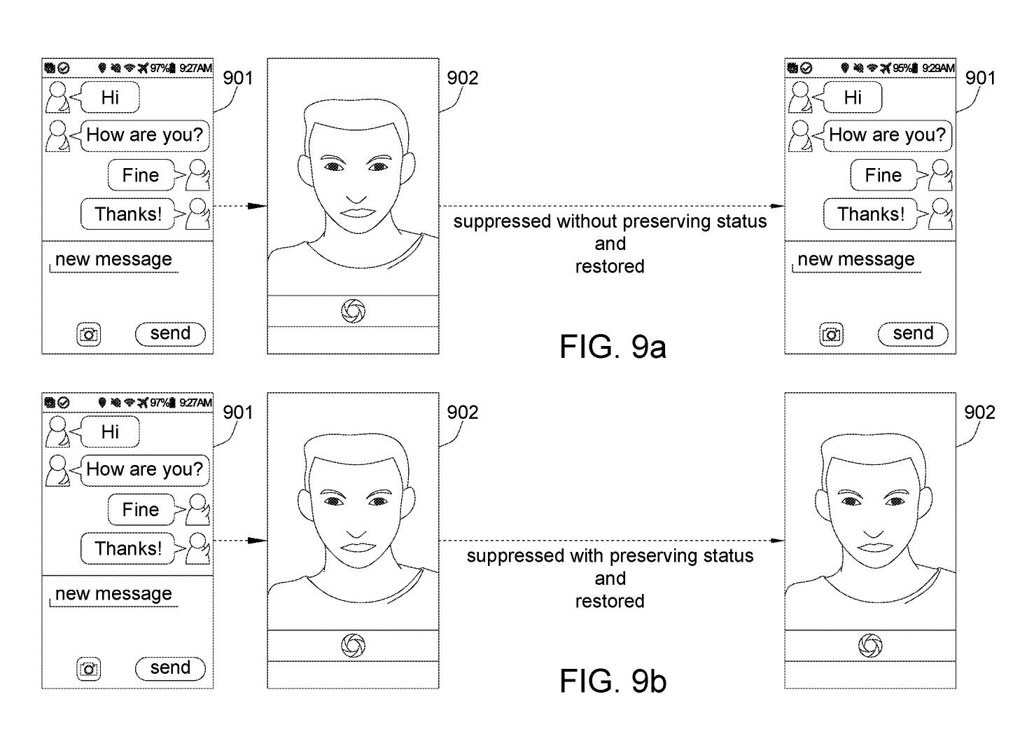

In an embodiment, a suppressing operation which includes killing suppressible programs may also be performed along with preserving a status for each suppressible program that is to be killed, so as to enable each killed suppressible programs to restore its former status when relaunched. As an example, please refer to FIGS. 9a and 9b illustrating a same scenario in which user first utilizes a messaging program having a UI 901, and then switches to a photographing program having a UI 902 when user wants to take and share a photo. Afterward, the messaging program is suppressed by a suppressing operation when a suppression condition is satisfied, and then restored by a restoring operation when a stop condition is satisfied. In FIG. 9a, the suppressing operation does not include preserving status, so the messaging program may restore to a default status, i.e., the UI 901. On the other hand, in FIG. 9b, the suppressing operation includes preserving status, so the messaging program may restore to the preserved former status, i.e., the UI 902, for consistent and uninterrupted user experience.

Step 116 (FIG. 1): the core unit 200 may be in a state without performing any suppressing operations, and iterate to step 108.

To sum up, by smart classification of suppressible programs which considers user experience and web-based categorization, along with diversified combinations (associations) of varied suppression conditions and suppressing operations, the invention may achieve automatic, flexible and adaptive suppression of suppressible programs, and therefore enhance and improve program resource management and software execution.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A method for improving software execution of an electronic device, comprising:
by a processor of the electronic device, identifying whether a target program is classified, according to whether the target program relates to an user interface of the electronic device, as one of suppressible programs; and
based on whether at least one suppression condition is satisfied, performing at least one suppressing operation on one or more of the suppressible programs.

2. The method of claim 1, wherein whether the target program is classified as one of the suppressible programs is further according to whether the target program is one of most recently executed programs.

3. The method of claim 1, wherein whether the target program is classified as one of the suppressible programs is further according to whether the target program is launched by another program that is not suppressed.

4. The method of claim 1 further comprising:
forming a foreground relation chain (FRC) by: including a first program as a member of the FRC if the first program is launched by user, and including a second program as a member of the FRC if the second program is launched by any member of the FRC; and
wherein whether the target program is classified as one of the suppressible programs is further according to whether the target program is launched by any member of the FRC.

5. The method of claim 1 wherein whether the target program is classified as one of the suppressible programs is further according to whether the target program is required by an operating system executed by the processor.

6. The method of claim 1 further comprising:
by the processor, accessing a database to obtain a category of the target program; and
wherein whether the target program is classified as one of the suppressible programs is further according to the category of the target program.

7. The method of claim 1, wherein:
the at least one suppression condition comprises a first suppression condition which is satisfied when a first event happens; and
the first event is one of the following:
launching a first predetermined program,
leaving a second predetermined program,
pausing a third predetermined program,
resuming a fourth predetermined program,
switching between two predetermined programs,
starting a telecommunication function,
idling an operation system executed by the processor,
waking the operation system,
locking a screen of the electronic device,
unlocking the screen,
turning on the screen, and
turning off the screen.

8. The method of claim 1, wherein:
the at least one suppression condition comprises a second suppression condition which is satisfied when a predetermined interval elapses after a predetermined event happens.

9. The method of claim 1, wherein:
the at least one suppression condition comprises a third suppression condition and a fourth suppression condition; and
whether the fourth suppression condition is satisfied relates to whether the third suppression condition is satisfied.

10. The method of claim 9, wherein performing the at least one suppressing operation based on whether the at least one suppression condition is satisfied comprises:
performing two different ones of the at least one suppressing operation respectively when the third suppression condition is satisfied and when the fourth suppression condition is satisfied.

11. The method of claim 1, wherein:
the at least one suppressing operation comprises a first suppressing operation and a second suppressing operation,
the first suppressing operation comprises: killing one or more of loaded ones of the suppressible programs, and
the second suppressing operation comprises: preventing one or more of unloaded ones of the suppressible programs from being launched by a user-unattended event.

12. The method of claim 1 further comprising:
keeping on performing the at least one suppressing operation on the one or more of the suppressible programs after the at least one suppression condition is satisfied, and
stopping performing the at least one suppressing operation on the one or more of the suppressible programs when a stop condition is satisfied.

13. The method of claim 1 further comprising:
after performing the at least one suppressing operation on the one or more of the suppressible programs, restoring one or more of the suppressed ones of the suppressible programs when a stop condition is satisfied.

14. The method of claim 1 further comprising:
preserving a status of one of the one or more of the suppressible programs when performing the at least one suppressing operation on the one or more of the suppressible programs, so as to enable the one of the one or more of the suppressible programs to restore the status when relaunched.

15. A processor of an electronic device, comprising:
a core unit; and
an interface circuit bridging between the core unit and a peripheral circuit of the electronic device;
wherein the core unit is arranged to:
identify at least one program which is classified as at least one suppressible program according to whether the at least one program relates to an user interface of the electronic device; and
based on whether at least one suppression condition is satisfied, perform at least one suppressing operation on one or more of the at least one suppressible program.

16. The processor of claim 15, wherein:
the at least one suppression condition comprises a first suppression condition and a second suppression condition;
the first suppression condition is satisfied when a first event happens; and
the second suppression condition is satisfied when a predetermined interval elapses after a second event happens.

17. The processor of claim 15, wherein:
the at least one suppression condition comprises a third suppression condition and a fourth suppression condition;
whether the fourth suppression condition is satisfied relates to whether the third suppression conditions is satisfied; and
performing the at least one suppressing operation based on the at least one suppression condition comprises: performing two different ones of the at least one suppressing operation respectively when the third suppression condition is satisfied and when the fourth suppression condition is satisfied.

18. The processor of claim 15, wherein the core unit is arranged to identify the at least one program which is classified as the at least one suppressible program further according to whether the at least one program is launched by another program that is not suppressed.

19. The processor of claim 15, wherein the core unit is arranged to identify the at least one program which is classified as the at least one suppressible program further according to whether the at least one program is one of most recently executed program.

20. The processor of claim 15, wherein the core unit is further arranged to form a foreground relation chain (FRC) by:
including a first program as a member of the FRC if the first program is launched by user, and including a second program as a member of the FRC if the second program is launched by any member of the FRC; and
wherein the core unit is arranged to identify the at least one program which is classified as the at least one suppressible program further according to whether the at least one program is launched by any member of the FRC.
